(19) United States
(12) Patent Application Publication
(10) Pub. No.: US 2026/0260525 A1
(43) Pub. Date: Sep. 3, 2026

(54) Vehicle Electronic Control Unit, Vehicle System and Software

(71) Applicant: MARELLI EUROPE S.P.A., Corbetta (IT)

(72) Inventors: Alessandro Fusari, Bologna (IT); Dionisio Di Giulio, Bologna (IT); Amedeo Romano, Bologna (IT); Cecilia Canullo, Bologna (IT); Stefano Sgatti, Bologna (IT)

(21) Appl. No.: 19/164,078

(22) PCT Filed: Mar. 13, 2024
(86) PCT No.: PCT/IB2024/052425

§ 371 Date: Sep. 10, 2025

(30) Foreign Application Priority Data
Mar. 14, 2023 (IT) 102023000004803

(51) Int. Cl. G07C 5/08

(52) U.S. Cl. CPC G07C 5/0808; G07C 5/0816

(57) ABSTRACT

A vehicle electronic control unit designed to execute one or more vehicle control functions of the operation of a vehicle system with a given level of vehicle safety integrity. A vehicle control function is configured to cause the vehicle system to operate in a nominal operating mode, wherein the vehicle system is caused to operate with nominal performances. The vehicle electronic control unit is further configured to: monitor the execution of the vehicle control functions to detect faults in the execution of the vehicle control functions, which result in the violation of a safety target established by the level of vehicle safety integrity; in case a fault in the execution of a vehicle control function is detected, trigger an emergency reaction to the detected fault, which involves performing an emergency function to cause the vehicle system to operate in an emergency operating mode, which is aimed at avoiding the violation of the safety target established by the level of vehicle safety integrity and wherein the vehicle system is caused to operate with degraded performances; monitor the operation of the vehicle system in the emergency operating mode to determine whether the emergency function is reaching its target or not; and in case the emergency function fails to reach its target, trigger a safety reaction, which involves performing a safety function, which is aimed at causing the vehicle system to reach a safety state.

### CROSS-REFERENCE TO RELATED APPLICATIONS

This Patent Application claims priority from Italian Patent Application No. 102023000004803 filed on Mar. 14, 2023, the entire disclosure of which is incorporated herein by reference.

### TECHNICAL FIELD OF THE INVENTION

The present invention relates, in general, to the field of vehicle functional safety, in particular in the event of emergency situations, such as failures in electronic control units (ECUs) of a vehicle, for example engine electronic control units.

The present invention, in particular, relates to an electronic control unit, in particular for the vehicle engine, designed to execute one or more vehicle control functions of the operation of a vehicle system with a given level of functional safety integrity of a vehicle.

The present invention finds application in any type of two or four-wheeled road vehicle, whether it is used for the transport of people or for the transport of goods.

### STATE OF THE ART

As is known, safety is one of the main issues particularly in the automotive market. The integration of electrical and electronic systems on vehicles requires development processes and safety content, as well as the ability to provide evidence that all reasonable safety targets are met.

New technologies, based on features distributed in various electronic control units typically developed by different suppliers, increase complexity, software content and mechatronic implementation and, as a result, the risks of systematic and random hardware faults.

The increased integration of electrical and electronic equipment (including programmable devices, as well as electromechanical components) into vehicle systems has led to the introduction of the international standard ISO 26262, which is derived from the functional safety standard IEC 61508 for industrial electrical/electronic systems.

The ISO 26262 standard provides process and product requirements to mitigate the effects of systematic and random hardware faults. This standard covers functional safety concepts applied to the automotive field, pursuing the absence of unacceptable risks related to the malfunction of electrical/electronic and programmable systems.

The ISO 26262 standard defines four Automotive Safety Integrity Levels (ASILs), specifying risks and risk reduction needs. For safety-related functions, ASIL may assume four different values, indicated by letters, from the highest, indicated by the letter D, which represents the most critical level in terms of safety integrity, down to the lowest level, indicated by the letter A, which represents the least stringency in terms of safety integrity. In addition, the ISO 26262 standard defines four Motorcycle Safety Integrity Levels (MSILs) where D indicates the highest level of integrity and A the lowest level of integrity; there is a standardized correspondence between ASIL and MSIL. The ISO 26262 standard also indicates QM (Quality Management) as the class assigned to functions that do not impose any functional safety requirements, for which development according to quality standards is sufficient.

### OBJECT AND SUMMARY OF THE INVENTION

In order to ensure the safety of a driver while driving in the event of a dangerous fault in one or more of the vehicle's electronic control units, that is in the event of one or more of the electronic control units experiencing a fault, resulting in the violation of a safety target established by the associated automotive safety integrity level, the electronic control unit is designed to execute an automatic fault detection strategy and a corresponding response strategy to the detected fault.

According to a first known solution, hereinafter also referred to as a fail-safe solution, the electronic control unit affected by the fault is configured to suddenly stop the automatic control function experiencing the failure; however, such a reaction could frighten the driver and jeopardize the controllability of the vehicle, as it could lead to a possible reduction in the user's ability to control the vehicle.

According to a second known solution, hereinafter also referred to as a fail-operational solution, the electronic control unit affected by the fault is designed to execute an automatic fault detection strategy, which allows a system switchover of the faulty electronic control unit to the degraded operating mode, to prevent violation of the safety targets. In particular, the degraded operating mode allows, in accordance with the ISO 26262 standard, to ensure safety in response to a fault without the sudden stop of one or more key functions of the vehicle (e.g., the propulsion in case the electronic control unit affected by the fault is the electronic control unit for the vehicle's engine). For example, the faulty engine electronic control unit, in case of a fail-operational architecture, is configured to limit the target torque value and allow the driver to complete the run without the vehicle becoming uncontrollable.

The Applicant noted that the fail-safe solution does not allow a smooth transition to a safe state, as the achievement of a safe state is generally abrupt and difficult to control by a driver who must reach this state. Furthermore, fail-operational solutions are generally expensive, since in order to implement the abovementioned functions, in particular the monitoring and fail-operational reaction functions, it is necessary to implement several redundant systems and components, which increase the number of components involved and, therefore, the costs associated therewith.

The object of the present invention is to provide an electronic control unit designed to execute one or more vehicle control functions of the operation of a vehicle system with a given level of vehicle safety integrity, which allows the drawbacks of the prior art to be at least partly overcome.

According to the present invention, an electronic control unit designed to execute one or more vehicle control functions of the operation of a vehicle system with a given level of vehicle safety integrity is provided as defined in the appended claims.

### BRIEF DESCRIPTION OF THE DRAWINGS

FIG. 1 shows a functional block diagram of an electronic control unit designed to execute vehicle control functions of the operation of a vehicle system with a vehicle safety integrity level according to the invention.

FIG. 2 shows a block diagram of emergency operating mode function monitoring operations implemented by an electronic control unit designed to execute one or more vehicle control functions of the operation of a vehicle system with a given level of vehicle safety integrity according to the present invention.

FIG. 3 shows a logic diagram of an emergency switch of an electronic control unit designed to execute one or more vehicle control functions of the operation of a vehicle system with a given level of vehicle safety integrity according to the present invention.

### DESCRIPTION OF PREFERRED EMBODIMENTS OF THE INVENTION

The present invention will now be described in detail with reference to the attached figures in order to allow a skilled person to implement it and use it. Various modifications to the described embodiments will be readily apparent to those skilled in the art and the general principles described may be applied to other embodiments and applications without however departing from the protective scope of the present invention as defined in the attached claims. Therefore, the present invention should not be regarded as limited to the embodiments described and illustrated herein but should be allowed the broadest protection scope consistent with the features described and claimed herein.

Unless otherwise defined, all technical and scientific terms used herein have the same meaning commonly understood by one of ordinary skill in the art to which the invention belongs. In case of conflict, the present specification, including the definitions provided, will control. Furthermore, the examples are provided for illustrative purposes only and as such should not be construed as limiting.

In particular, the block diagrams included in the attached figures and described below are not to be understood as a representation of the structural features, i.e. construction restrictions, but must be understood as a representation of functional features, i.e. intrinsic properties of the devices defined by the effects obtained, that is to say functional restrictions, which can be implemented in different ways, so as to protect the functionalities thereof (operational capability).

In order to facilitate the understanding of the embodiments described herein, reference will be made to some specific embodiments and a specific language will be used to describe the same. The terminology used herein is used for the purpose of describing particular embodiments only and is not intended to limit the scope of the present invention.

As also better described below, the present invention relates to an electronic control unit configured to reduce the torque from a starting value down to zero by following a ramp or to limit the target torque value to a filtered value in the event of a fault; in this way, the length of time during which the vehicle remains in the degraded operation mode (i.e., within an emergency operation time frame) is sufficient for the driver to bring the vehicle into a state free of unreasonable risks, i.e., a safe state, for example on the roadside or in a pull-in, thus preserving the controllability of the vehicle by the driver. In addition, the electronic control unit affected by the fault is configured to supervise the operations in the emergency operating mode by means of related monitoring functions, implemented in the same electronic control unit, and developed according to the safety standards required for the same monitoring functions.

The electronic control unit according to the present invention, comprising functions implemented in the emergency operating mode and the monitoring thereof, is developed, as a whole, according to the functional safety standards required by the application, thus ensuring compliance with the safety targets; in particular, the functions implementing fault detection and emergency mode monitoring in the event of faults are developed according to the required functional safety integrity level. The implementation of the emergency operating mode according to a quality or safety standard lower than its monitoring functions ensures lower implementation costs without compromising compliance with the functional safety requirements, as the implementation of the emergency mode is monitored periodically by functions developed according to appropriate safety standards.

If the emergency functions are not performed correctly or within a predefined time interval, the electronic control unit is designed to perform fail-safe, i.e. error-proof, reaction functions to ensure safety within a tolerance time interval for an emergency operating mode operation, which is defined as the specified period of time during which the emergency operating mode operation can be maintained without an unreasonable level of risk, in particular according to the ISO 26262 standard. In particular, when implementing the fail-safe reaction functions, the electronic control unit is configured to determine and execute an independent shut-off path to reach the safe state (e.g., engine shut-off) only when the operation in the emergency operating mode fails.

To verify whether the operation in the emergency operating mode has been successful, the electronic control unit is configured to receive and process one or more feedback signals to implement functions for monitoring the emergency operating mode operation and, therefore, any fail-safe reaction functions, to assess whether, for example, the vehicle is slowing down in the event of a failure of the engine electronic control unit. In this way, the electronic control unit is configured to extend the time interval of the operation in the emergency operating mode, as it is performing operations to achieve a safer and more controllable operating state, in which there is no violation of the predefined safety target.

The electronic control unit is also configured to implement a warning strategy to warn the driver of the reduced functionality due to the emergency operating mode and to prevent the driver from losing control of the vehicle; in particular, the electronic control unit is configured to generate notifications, such as haptic, audio and/or visual notifications, and transmit them so that they can be made available on a network, such as a Controller Area Network (CAN), so that they can be received by further electronic control units, for example to make sure that they adapt their control laws to the new situation of the vehicle.

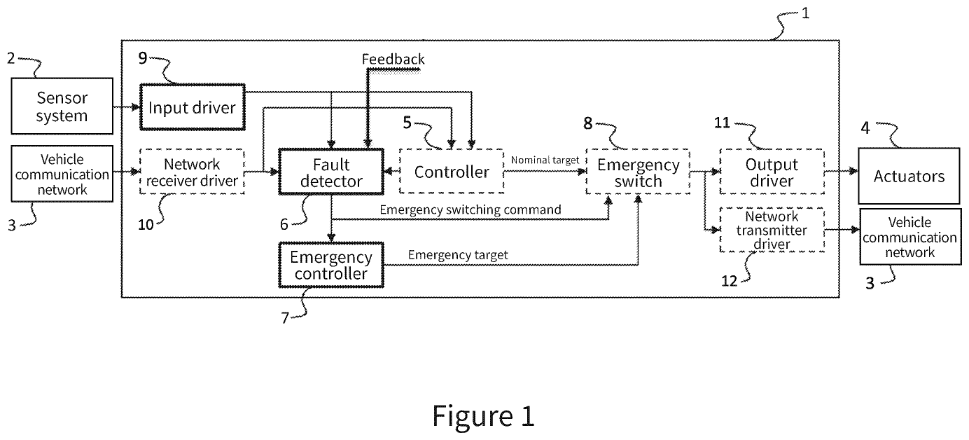

FIG. 1 shows an electronic control unit 1 designed to execute one or more vehicle control functions of the operation of a vehicle system (not shown) with a given level of vehicle safety integrity. Hereinafter and without any loss of generality, the electronic control unit 1 is an electronic control unit for the engine of a vehicle.

In particular, a vehicle control function of the electronic control unit 1 is configured to cause the vehicle system to operate in a nominal operating mode, in which the vehicle system is caused to operate with nominal performances. It is noted that hereinafter the term ‘nominal’ indicates values or targets or modes requested by a user following a specific action, detected by the sensor system 2 (e.g., the equivalent torque value requested by the user for example during an acceleration, taking into account torque losses and the presence of any additional loads), in non-problematic situations, i.e., in which no fault is present.

The vehicle electronic control unit 1 is configured to:
monitor the execution of the vehicle control functions to detect faults in the execution of the vehicle control functions, which result in the violation of a safety target established by the level of vehicle safety integrity;
in case a fault in the execution of a vehicle control function is detected, trigger an emergency reaction to the detected fault, which involves performing an emergency function to cause the vehicle system to operate in an emergency operating mode, which is aimed at avoiding the violation of the safety target established by the level of vehicle safety integrity and in which the vehicle system is caused to operate with degraded performances;
monitor the operation of the vehicle system in the emergency operating mode to determine whether the emergency function is reaching its target or not; and
in case the emergency function fails to reach its target, trigger a safety reaction (also referred to as a fail-safe reaction), which involves performing a safety function aimed at causing the vehicle system to reach a safe state.

In particular, as anticipated above, the emergency function and the related monitoring functions are developed according to functional safety standards required by the application, thus ensuring compliance with the corresponding safety targets; in particular, the functions implementing fault detection and emergency mode monitoring in the event of faults are developed according to the functional safety integrity level required by the application. Moreover, the implementation of the emergency operating mode occurs according to a quality or safety standard lower than its monitoring functions; in addition, the functions implementing the emergency mode are monitored periodically by functions developed according to appropriate safety standards.

Therefore, the emergency function is designed according to quality standards, in particular according to QM quality level (specifically, ISO 26262-3:2018, in particular as specified in Provision 6.4.3.10, Note 2 of the text of the same ISO, https://www.iso.org/obp/ui/#iso:std:iso:26262:-3:ed-2:v1:en), or according to a safety standard with a given level of vehicle safety integrity which is lower compared to the monitoring functions of the emergency function, and the operation of the vehicle system in the emergency operating mode is monitored by implementing one or more fault detection functions developed according to a level of vehicle safety integrity which is higher than that of the emergency function and is predetermined based on the highest risk of fault associated with the vehicle electronic control unit 1.

The vehicle electronic control unit 1 further comprises:
a main controller 5 designed to communicate with a vehicle sensor system 2 and with a vehicle communication network 3 to receive input data indicative of the operation of the vehicle system and to calculate, based on the input data, and to output, a nominal target for the vehicle system so that it operates in the nominal operating mode;
a fault detector 6 designed to communicate with a vehicle sensor system 2 and with a vehicle communication network 3 to receive input data indicative of the operation of the vehicle system and to detect, based on the input data, and to generate as well as to output an emergency switching command in the presence of a fault in the execution of a vehicle control function;
an emergency controller 7 designed to communicate with the fault detector 6 to receive notifications on the existence of faults in the execution of the vehicle control function, which result in the violation of a safety target established by the level of vehicle safety integrity, and to calculate as well as to output an emergency target for the vehicle system so that the latter operates in the emergency operating mode; and
an emergency switch 8 designed to communicate with the main controller 5 to receive, from the latter, the nominal target, with the emergency controller 7 to receive, from the latter, the emergency target, and with the fault detector 6 to receive, from the latter, the emergency switching command and to provide the vehicle system with the nominal target in the absence of the emergency switching command and with the emergency target in the presence of the emergency switching command.

The electronic control unit 1 further comprises:
an input driver 9 designed to communicate with the vehicle sensor system 2 to receive the input data indicative of the operation of the vehicle system;
a vehicle communication network receiver driver 10 designed to communicate with the vehicle communication network 3 to receive input notifications indicative of the operation of the vehicle;
an output driver 11 designed to communicate with one or more actuators 4 to output commands concerning the nominal target or the emergency target for the vehicle system so that the latter operates in the nominal operating mode or in the emergency operating mode; and
a vehicle communication network transmitter driver 12 designed to communicate with the vehicle communication network 16 to transmit output notifications concerning the operation of the vehicle system.

It is noted that the input driver 9, the fault detector 6, and the emergency controller 7 are designed to implement monitoring functions, which are developed according to predetermined safety standards. On the other hand, the vehicle communication network receiver driver 10, the output driver 11, the vehicle communication network transmitter driver 12, the controller 5, and the emergency switch 8 are designed to implement the nominal and emergency functions and, in general, functions developed according to a lower integrity level compared to the monitoring functions.

Therefore, in light of the above, the electronic control unit 1, in particular the controller 5, is configured to receive and process data and/or information from components external thereto, for example from the sensor system 2 and the vehicle communication network 3, to be able to control the operation of the one or more actuators 4 and to provide information to the vehicle communication network 16.

The fault detector 6 is therefore designed to implement nominal function monitoring, in particular by implementing one or more of the following monitoring strategies:
integrity checks on the input data (i.e., both on a wired connection, for example connecting the parts of the vehicle to which the electronic control unit 1 is connected, for example the sensor system 2, and on the connection to the vehicle communication network 3) received by the electronic control unit 1;
detection of a violation of one or more pre-set safety targets for the electronic control unit 1;
a request for the activation of a safe state; and
integrity checks on the safety critical functions of the electronic control unit 1.

As mentioned above, when the fault detector 6 detects a fault in the execution of the vehicle control functions, the same fault detector 6 is designed to generate an emergency alert for the emergency controller 7; accordingly, the emergency controller 7 is designed to transmit the emergency target to the emergency switch 8, and the fault detector 6 is designed to control the emergency switch 8 to provide emergency commands to enable the vehicle system to operate in the emergency operating mode, specifically to control the one or more actuators 4. By way of example, emergency commands relating to emergency values are values that can be assumed by quantities implemented by the actuators 4 which decrease over time, according to some embodiments of the invention even reaching zero, starting from nominal values assumed by the quantities implemented by the actuators 4.

In addition, the fault detector 6 is designed to monitor the operation of the vehicle system in the emergency operating mode to determine whether the emergency function is reaching its target or not, or to monitor whether the execution of the emergency functions has occurred by reading feedback data and/or notifications 17 input to the electronic control unit 1.

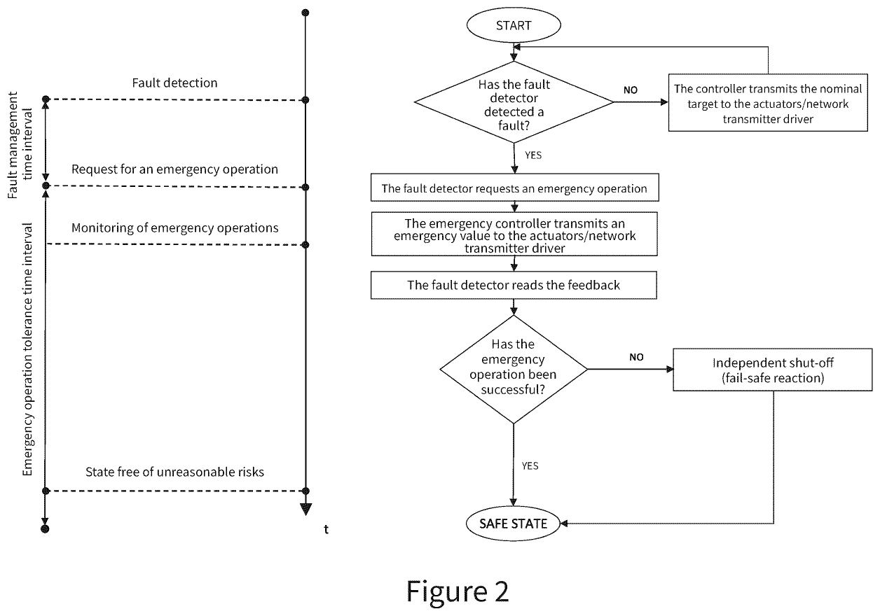

Some operating modes of the present electronic control unit 1 are now described, in particular with reference to FIG. 2.

In a nominal condition, the controller 5 is designed to calculate a nominal value of quantities, e.g., the torque, to be output as nominal commands to enable the vehicle system to operate in a nominal operating mode, in particular to control the one or more actuators 4, in particular taking into account various vehicle conditions and parameters (e.g., requests from the driver, torque requests from external systems, friction braking torque, and the like). The fault detector 6 is therefore designed to monitor the vehicle control functions, in particular by reading data and notifications input to the electronic control unit 1 to detect faults in the execution of the vehicle control functions. In the absence of faults, the fault detector 6 is designed to set the emergency switch 8 to the nominal target and thus allow the vehicle system to operate in the nominal operating mode, i.e., to transmit nominal commands associated with nominal values assumed by the quantities implemented by the actuators 4.

In the event of a request to execute emergency functions, i.e., in the event of a fault, the fault detector 6 is designed to set the emergency switch 8 to the emergency target and to signal the presence of a fault to the emergency controller 7, thus initiating an emergency reaction to the fault; considering the conditions and parameters of the vehicle, in particular knowing the last valid value of the nominal target before the fault detection, the emergency controller 7 is designed to calculate an emergency target for the quantities implemented by the actuators 4 and to transmit it to the emergency switch 8 so that the electronic control unit 1 outputs the emergency commands, causing the vehicle system to operate in the emergency operating mode. In particular, the emergency controller 7 is designed to determine, as emergency values, alternatively:
a target value which decreases over time following a ramp down to zero; and
a target value of operating quantities, e.g., the torque, limited to a filtered value.

In both cases, according to the present invention, particular attention is paid to the definition of the target to avoid abrupt discontinuities in the target delivered to the control chain which includes the emergency switch 8, the output driver 11, and the actuators 4.

Since the fault detector 6 commands the emergency switch 8 to switch to the emergency value, the nominal value provided by the controller 5 is not selected and therefore the output driver 11 receives the data indicative of the first emergency value for the operating quantities so that it can transmit them to the one or more actuators 4. Once the emergency functions are requested to be executed, the fault detector 6 is designed to monitor the operation of the vehicle system in the emergency operating mode to determine whether the emergency function is reaching its target or not, or to monitor whether the execution of the emergency functions has occurred by reading the feedback data and/or notifications 17 input to the electronic control unit 1. In this case, the fault detector 6 is designed to alternatively verify that:
the quantities indicative of the operation of the vehicle system, e.g., the speed, decrease in a time that can be associated with a given known characteristic depending on the conditions of the vehicle; and
the quantities indicative of the operation of the vehicle system, e.g., the engine speed, are below a threshold that can be associated with the vehicle conditions.

If the fault detector 6 verifies that there is an unwanted evolution of the operation of the vehicle system, the same fault detector 6 is designed to trigger a safety reaction involving the performance of a safety function aimed at causing the vehicle system to reach a safe state, i.e., to request a safety reaction to implement an independent shut-off path to bring the vehicle to a safe state. If the emergency operation is requested while the vehicle is going downhill, the monitoring of the emergency operation may not be reliable depending on the type of feedback used: therefore the safety reaction is requested in all cases, in fact, the loss of propulsion downhill is acceptable as the vehicle does not stop suddenly, since a non-zero traction value remains and provided that the general safety conditions of the vehicle, such as for example the braking capacity, are ensured.

It should be noted that the role played by the fault detector 6 is of particular importance since the integrity level of the control chain for the emergency operating mode is lower than the integrity level of the fault detector 6.

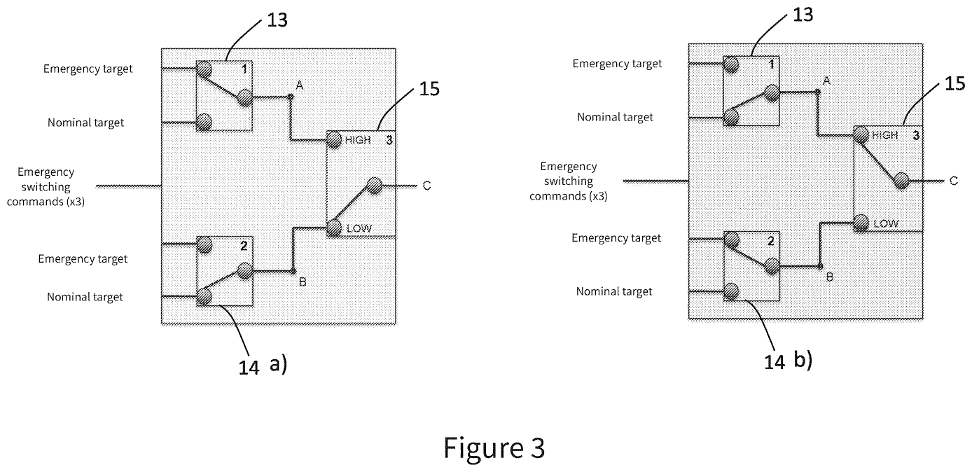

With reference to FIG. 3 and as partially anticipated in the preceding paragraphs, the emergency switch 8 is designed, by default, to output the quantity values for controlling the one or more actuators 4 according to the commands received from the fault detector 6.

The emergency switch 8 comprises:
a first and a second input switch 13, 14 designed to receive the nominal target from the main controller 5, the emergency target from the emergency controller 7 and the emergency switching command from the fault detector 6 to generate respective first and second outputs A, B indicative, alternatively, of the nominal target in the absence of the emergency switching command and of the emergency target in the presence of the emergency switching command; and
an output switch 15 designed to receive the first and the second output A, B from the first and the second input switch 13, 14 and to provide the vehicle system with the nominal target in the absence of the emergency switching command and with the emergency target in the presence of the emergency switching command.

Since the emergency switch 8 can be affected by faults dependent on the control functions, according to one aspect of the present invention, the electronic control unit 1 is configured to verify the integrity of the emergency switch 8 to ensure its correct operation; therefore, the electronic control unit 1 is configured to periodically test the emergency switch 8 to assess its integrity and correct operation.

In particular, the electronic control unit 1 is designed to perform a safety function to control the switches 13, 14 and 15 and decide, through a periodic check, whether one of them is not able to switch correctly as expected. The above periodic test can be performed in appropriate vehicle conditions and repeated periodically, as the output C is indicative of the nominal values in the absence of a fault. In detail, the outputs A, B and C are an indication of the presence of possible faults, i.e., they are indicative of the presence of a malfunction of the emergency switch 8, in one or more of the switches 13, 14 and 15, and allow the electronic control unit 1 to detect which of the switches 13, 14 and 15 is defective and to activate the switching of the other switches 13, 14 and 15 or, alternatively, to request a safety reaction or an alarm strategy. In the event that one of the switches 13, 14 and 15 is defective or malfunctioning, the duration of the test is short enough to minimize any disturbance effect. In addition, if the emergency switch 8 is not affected by any fault, there will be no disturbance.

By way of example, in the absence of a fault and under periodic test conditions, the electronic control unit 1 is configured to alternatively provide, as an emergency target, nominal values (i.e., nominal value NT) or emergency values (i.e., emergency value ET) to each of the input switches 13, 14 and to the output switch 15 so that the latter generates an output C indicative of the nominal values, or assumes the same value assumed by the output of the outputs A, B which has assumed the nominal value NT. In the absence of a fault, the outputs A, B will alternatively assume nominal values NT or emergency values ET consistently with the emergency switching commands received, and the output C will assume the nominal value NT. In this way, there will be no disturbance if there is no fault. For example, if the output A assumes the nominal value NT and the output B assumes the value ET, the output C will assume the same value as the output A, i.e., the nominal value NT.

Otherwise, if there is a fault, at least one of the values assumed by the outputs A, B, C will be inconsistent with the emergency switching commands received and it will therefore be possible to identify the faulty switch and carry out a targeted action. For example, in the event of a fault of the second input switch 14, this generates a second output B whose value is opposite to the expected value (for example, instead of assuming an emergency value ET, it assumes a nominal value NT); on the other hand, the first output A assumes a value consistent with the emergency switching commands received (for example, it assumes a nominal value NT) and the output C assumes a value consistent with the emergency switching commands received (for example, it assumes a nominal value NT). This situation also occurs in the event that the first input switch 13 fails (i.e., the first output A assumes a value different from that provided by the emergency switching commands) and in the event that the output switch 15 fails (i.e., the output C assumes a value different from that provided by the emergency switching commands).

In light of the above, the advantages of the present invention are apparent.

In particular, as is also apparent from the description above, the present solution allows an emergency operation strategy to be implemented with many advantages, including low implementation costs; in fact, when a fault occurs, the emergency operation is requested and can be maintained to reach a state free of unreasonable risk levels, without there being a sudden and strong safety intervention, as happens for example in the known solutions mentioned above.

In addition, with the aim of avoiding the sudden stop of a key function of the vehicle, such as for example the propulsion, the present solution allows safety targets to be considered, particularly with regard to the vehicle engine, such as the prevention of unwanted accelerations and the prevention of sudden loss of propulsion, by implementing strategies to achieve a gradual transition to the safe state, which does not therefore result in a sudden loss of propulsion.

Furthermore, the present solution is cost-effective since it has a highly testable architecture relying on safety elements with a lower integrity compared to that of their monitoring elements, there is no need to include hardware redundancies in the same architecture, and low-impact software changes are required. Moreover, the present solution ensures greater controllability, as it allows a gradual transition to the safe state to improve the controllability of the vehicle compared to what is described with reference to the known solutions; by way of example, the present solution enables efficient handling of a vehicle, such as a motorcycle, while the propulsion is gradually reduced until the vehicle comes to a standstill to avoid unintentional acceleration resulting from a fault.

1. A vehicle electronic control unit (1) designed to execute one or more vehicle control functions of the operation of a vehicle system with a given level of vehicle safety integrity;
a vehicle control function is configured to cause the vehicle system to operate in a nominal operating mode, wherein the vehicle system is caused to operate with nominal performances;
the vehicle electronic control unit (1) is further configured to:
monitor the execution of the vehicle control functions to detect faults in the execution of the vehicle control functions, which result in the violation of a safety target established by the level of vehicle safety integrity;
in case a fault in the execution of a vehicle control function is detected, trigger an emergency reaction to the detected fault, which involves performing an emergency function to cause the vehicle system to operate in an emergency operating mode, which is aimed at avoiding the violation of the safety target established by the level of vehicle safety integrity and wherein the vehicle system is caused to operate with degraded performances;
monitor the operation of the vehicle system in the emergency operating mode to determine whether the emergency function is reaching its target or not; and
in case the emergency function fails to reach its target, trigger a safety reaction, which involves performing a safety function, which is aimed at causing the vehicle system to reach a safety state.

2. The vehicle electronic control unit (1) according to claim 1, wherein the emergency function is designed according to quality standards or according to a safety standard with a given level of vehicle safety integrity which is lower compared to the monitoring functions of the emergency function, and the operation of the vehicle system in the emergency operating mode is monitored by implementing one or more fault detection functions developed according to a level of vehicle safety integrity which is higher than the one of the emergency function and is predetermined based on the highest risk of fault associated with the vehicle electronic control unit (1).

3. The electronic control unit (1) according to claim 1, comprising:
a main controller (5) designed to communicate with a vehicle sensor system (2) and with a vehicle communication network (3) to receive input data indicative of the operation of the vehicle system and to calculate, based on the input data, and to output a nominal target for the vehicle system so that it operates in the nominal operating mode;
a fault detector (6) designed to communicate with a vehicle sensor system (2) and with a vehicle communication network (3) to receive, from them, input data indicative of the operation of the vehicle system and to detect, based on the input data, and to generate as well as to output an emergency switching command in the presence of a fault in the execution of a vehicle control function;
an emergency controller (7) designed to communicate with the fault detector (6) to receive notifications on the existence of faults in the execution of the vehicle control function, which result in the violation of a safety target established by the level of vehicle safety integrity, and to calculate as well as to output an emergency target for the vehicle system so that the latter operates in the emergency operating mode; and
an emergency switch (8) designed to communicate with the main controller (5) to receive, from the latter, the nominal target, with the emergency controller (7) to receive, from the latter, the emergency target, and with the fault detector (6) to receive, from the latter, the emergency switching command and in order to provide the vehicle system with the nominal target in the absence of the emergency switching command and with the emergency target in the presence of the emergency switching command.

4. The electronic control unit (1) according to claim 3, wherein the emergency switch (8) comprises:
a first and a second input switch (13, 14) designed to receive the nominal target from the main controller (5), the emergency target from the emergency controller (7) and the emergency switching command from the fault detector (6) to generate respective first and second outputs (A, B) indicative, alternatively, of the nominal target in the absence of the emergency switching command and of the emergency target in the presence of the emergency switching command; and
an output switch (15) designed to receive the first and the second output (A, B) from the first and the second input switch (13, 14) and to provide the vehicle system with the nominal target in the absence of the emergency switching command and with the emergency target in the presence of the emergency switching command.

5. The electronic control unit (1) according to claim 3 and further comprising:
an input driver (9) designed to communicate with the vehicle sensor system (2) to receive the input data indicative of the operation of the vehicle system;
a vehicle communication network receiver driver (10) designed to communicate with the vehicle communication network (3) to receive input notifications indicative of the operation of the vehicle;
an output driver (11) designed to communicate with one or more actuators (4) to output commands concerning the nominal target or the emergency target for the vehicle system so that the latter operates in the nominal operating mode or in the emergency operating mode; and
a vehicle communication network transmitter driver (12) designed to communicate with the vehicle communication network (16) to transmit output notifications concerning the operation of the vehicle system.

6. A vehicle system comprising an electronic control unit (1) designed to perform one or more vehicle control functions of the operation of a vehicle system with a given level of vehicle safety integrity according to claim 1.

7. A software, which can be loaded into and can be executed by an electronic control unit (1) according to claim 1, the software being designed so that, when it is executed, the electronic control unit (1) becomes designed to perform one or more vehicle control functions of the operation of a vehicle system with a given level of vehicle safety integrity as claimed in claim 1.
